(19) United States
(12) Patent Application Publication
(10) Pub. No.: US 2002/0019822 A1
(43) Pub. Date: Feb. 14, 2002

(54) Database management system, method and program

(76) Inventors: Yumiko Seki, Toyonaka (JP); Kazuhisa Ishida, Neyagawa (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/811,557

(22) Filed: Mar. 20, 2001

(30) Foreign Application Priority Data
Aug. 4, 2000 (JP) 2000-242753

(51) Int. Cl. G06F 17/30

(52) U.S. Cl. 707/10; 707/2

(57) ABSTRACT

Different heterogeneous databases that are accessible in at least one of the data management method and the data structure. A heterogeneous database manager accepts an access request in a common format, identifies a database management system to be accessed, and accesses the database management system to acquire a database and a data item to generate an access information table. The heterogeneous database manager references the table and generates a access command specific to the database management system to manage, collect, create, and update data desired by the user.

### BACKGROUND OF THE INVENTION

The present invention relates to a database management system and a database management device used to access a database.

To process data, video data, still image data, and sound data stored in a conventional database, the user who accesses the database must have knowledge on the database and its structure.

An earlier patent disclosure dealing with this is found in JP-A-11-296532. In this JP-A definition information on the location of data items, data representation format of data items, and methods for conversion between data representation formats are created. In response to an item search request or a search condition from a user, the database for one or more items corresponding to the request is checked. From the definition information, information required for searching for all items is obtained.

The prior art described above predefines methods for converting data from one data structure to another and from one data representation format to another to allow the user to access heterogeneous databases via a common interface. To get information, inquiry statements are generated based on the definition information.

### SUMMARY OF THE INVENTION

However, the prior art described above does not disclose how definition information is generated from the data structure and the data representation format used in a database. That is, the prior art does not disclose how an added database is defined.

It is an object of the present invention to provide a database management method and a database management device allowing the user to access a database on a network whose data management method and data item structure are not known.

It an another object of the present invention to provide a database management method and a database management device maintaining compatibility between databases with a subordination relation and databases with no subordination relation.

One of the aspects of the present invention for achieving the above objects acquires information on the structure of a database and a data item that will be accessed and access the database and the data item using the information on the structure of a database and a data item to which an application issues an access request.

Another aspect of the present invention for achieving the above objects makes a database manage at least the number of attached files to be accessed and information on pointers to attached files and provides information on the number of attached files and attached file storage locations based on an access request from an application.

### BRIEF DESCRIPTION OF THE DRAWINGS

FIG. 1 is a diagram showing the system configuration in which a heterogeneous database management is used.

FIG. 2 is a diagram showing the overall operation of the system.

FIGS. 3A and 3B are diagrams each showing an example of an access request.

FIGS. 4A to 4D are diagrams showing examples of databases.

FIGS. 5A and 5B are diagrams showing examples of output information.

FIG. 6 is a diagram showing an example of a definition table.

FIG. 7 is a diagram showing an example of an access information table.

FIGS. 8A to 8C are diagrams showing examples of a command translation table.

FIGS. 9A to 9C are diagrams showing examples of a database name list.

FIGS. 10A and 10B are diagrams showing examples of a data item list.

FIG. 11 is a diagram showing the configuration of a database access manager.

FIG. 12 is a diagram showing the overall processing flow of the access manager.

FIGS. 13A to 13D are diagrams each showing an example of how the access information table is generated.

FIGS. 14A and 14B are diagrams showing access requests translated through command translation.

FIG. 15 is a flowchart showing how a database management system is identified.

FIG. 16 is a flowchart showing how a database name list is acquired.

FIG. 17 is a flowchart showing how a data item list is acquired.

FIG. 18 is a flowchart of a processor.

FIG. 19 is a diagram showing examples of command translation list tables.

### DETAILED DESCRIPTION OF THE EMBODIMENTS

A first embodiment of the present invention will be described in detail with reference to the accompanying drawings.

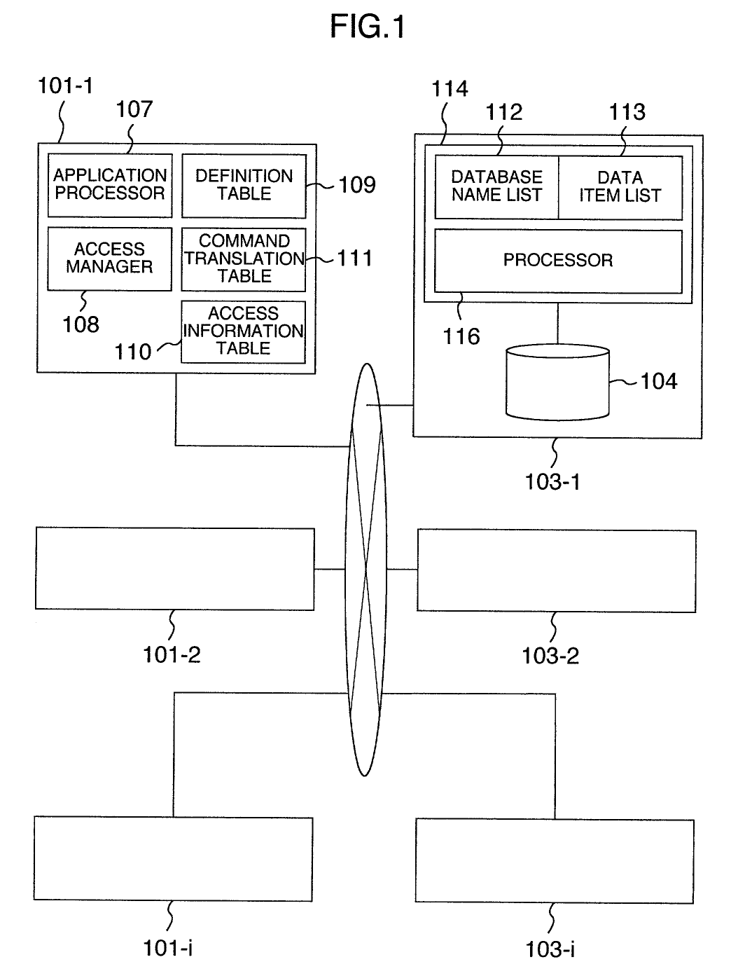

FIG. 1 shows the structure of a system to which the present invention is applied. The system comprises a plurality of database management systems 103 (103-1, 103-2, . . . , 103-i) and a plurality of application systems 101 (101-1, 101-2, . . . , 101-i) that access the database management system 103 to get, update, and delete data. The application systems 101 and the database management systems 103 are connected via a network. In an environment like this where a plurality of database management systems are connected, the user may get, update, and delete desired data without concerning about database structures.

The structure of each system will be described.

The application system 101 comprises an application processor 107 that provides a user interface via which a user input request is accepted and processing result data such as an image, a document, and sound is output, an access manager 108 that accesses database management systems, a definition table 109 used to check whether or not access to a database management system is allowed, an access information table 110 in which information for accessing databases is stored, and a command translation table 111 that generates an access request to a database.

Processing performed by the application processor 107 and the access manager 108 may be implemented by programs stored on a CD-ROM, floppy disk, or magneto optical disc. The programs may be those installed from these storage media or via a network.

Next, the database management system will be described.

The database management system 103 comprises one or more databases 104 and a database management system 114 that manages the databases.

The database management system 114 comprises a processor 116 that transfers data and commands to or from the application system 101 and obtains or deletes data from, and updates data of, the database 104, a database name list table 112 in which the names of the managed databases are defined, and a data item list table 113 in which the data items stored in the databases are defined.

The items recorded in the data item list 113 may be created by the processor 116 reading them from the database 104 or may be defined by an input device or a display not shown in the figure.

The database management systems in this embodiment are assumed to use different data management methods, data structures, or access methods. Different data management methods refer to the following. When the user in a database management system can access databases on physically-distributed machines with data managed in hierarchical structures in the databases but, on the other hand, the user in another database management system defines a plurality of relations among data to manage data in the databases, these two database management systems are said to differ in the data management method.

Different data structures refer to the following. When data is stored according to a parentage relation in a database management system but, on the other hand, data is stored in tables in another data management system with data relation information stored in another table for mutual reference, these two data management systems are said to differ in the data structure. Two database management systems, each having its own items in the database, are also said to differ in the data structure.

Similarly, when the commands used by the user in a database management system to access data differ from those used by the user in another database management system, these two database management systems are said to differ in the access method.

As described above, there are different database management systems in the embodiment. However, the processor 116 of each database management system 103 does the same processing. That is, in response to an access request, the processor 116 gets or deletes data from, or updates the data of, a managed database.

To access one of different database management systems (heterogeneous database management systems), the access manager 108 generates an appropriate request.

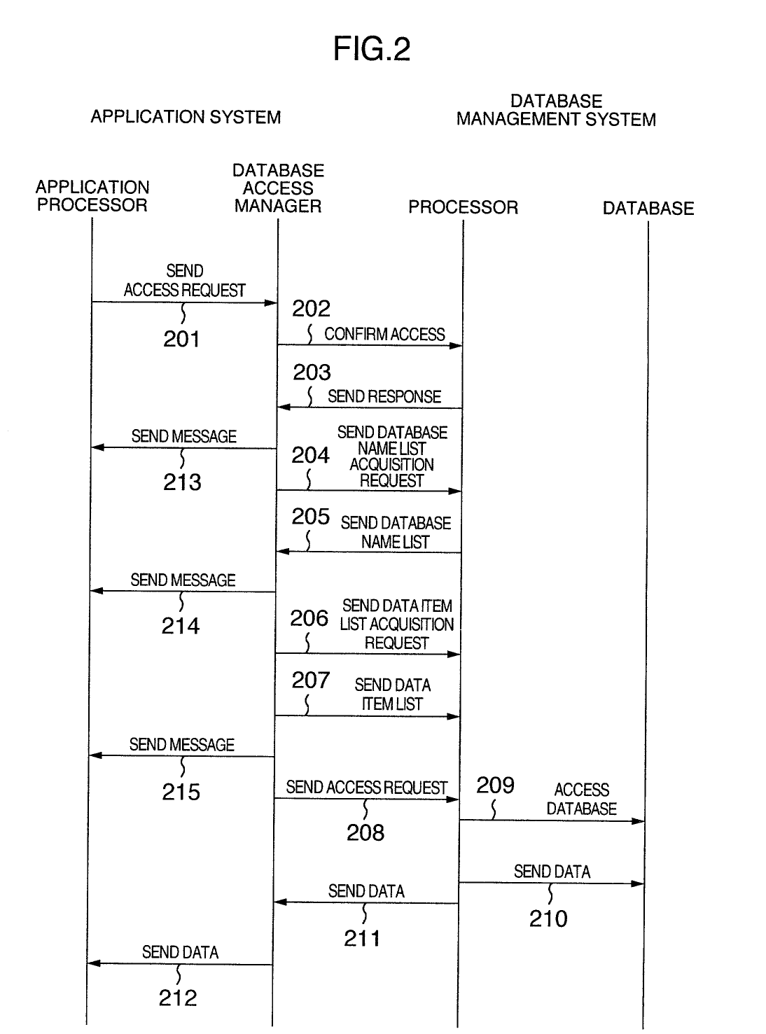

Now, the overall operation of the system shown in FIG. 1 will be described with reference to FIG. 2.

The user uses the application processor 107 to enter a database access request (get, delete, or update data), a user ID, and a password. The entered request is converted to a predetermined common format and, together with the user ID and the password, sent to the access manager 108 (201). Upon receiving this request, the access manager 108 sends access confirmation information, the user ID, and the password to the processor 116 (202). The processor 116 checks the access confirmation information, user ID, and password and, if access is permitted, sends access permission information to the access manager 108 (203). In response to the access permission information, the access manager 108 sends a database name list acquisition request to the processor 116 (204), and the processor 116 sends the database name list back to the access manager 108 (205). Next, the access manager 108 sends a data item list acquisition request to the processor 116 that manages the database whose information has been received (206), and the processor 116 sends the data item list back to the access manager 108 (207). The access manager 108 uses the acquired database name and the data item list to generate an access request satisfying the access request from the application processor 107 and, in addition, translates the request to a command with which the processor 116 may access data. The access manager 108 uses the command, which was generated through translation, to output an access request to the database management system (208). In response to the access request, processor 116 executes processing based on the received request (209, 210), and sends the execution result to the access manager 108 (211). The access manager 108 sends the execution result to the application processor 107 (212). In this way, an access request entered from the application processor 107 is sent to a desired database management system for execution. If the database management system cannot be accessed, if the database name cannot be acquired, or if the data item list cannot be acquired, a message is sent to the application processor 107 (213, 214, 215).

In the operation described above, the user does not specify a database management system and a database when making an access request. When the database management system that may be accessed is known in advance, steps 202 and 203 are omitted. In this case, the user ID and the password are sent to the processor 116 in the steps that follow. In addition, when the database name is known in advance, steps 204 and 205 are omitted.

In this embodiment, though a database management system that may be accessed, a database name list, and a data item list are acquired separately, they may be processed together. If a user access request specifies sufficient parameters (for example, all parameters except a database management system or a database name are specified), it is more efficient to acquire the information separately. On the other hand, if a user access request specifies a few parameters (for example, neither the database management system nor the database name is not specified), it is more efficient to acquire the information together. Either method may be accepted. In the description of the embodiment, the information is acquired separately.

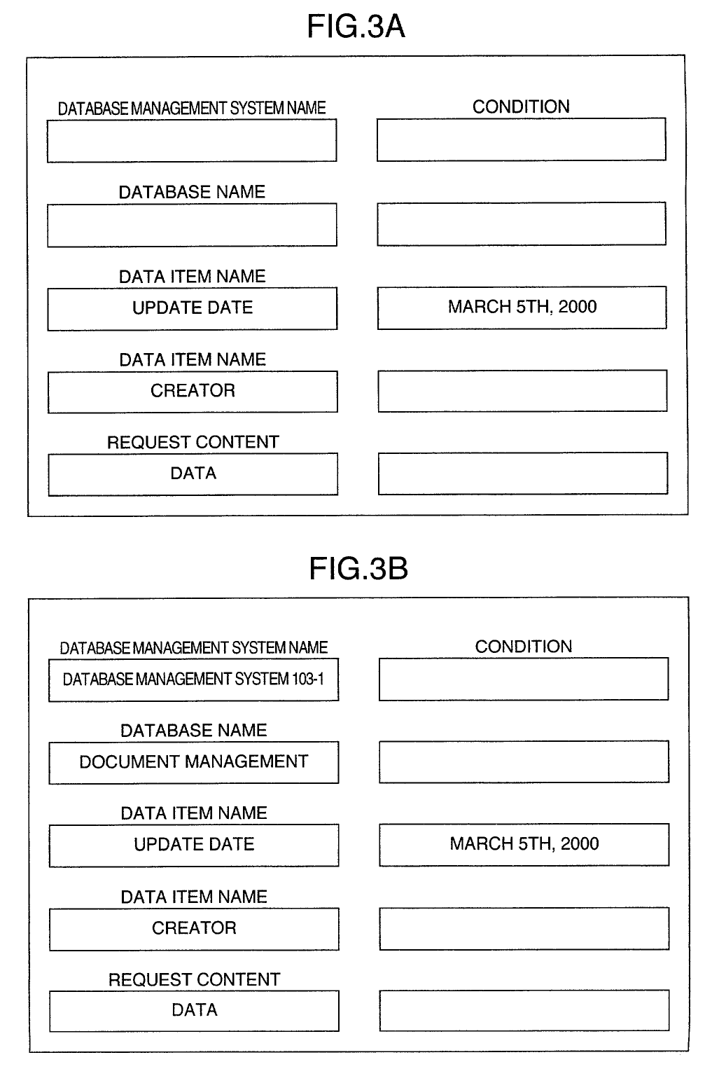

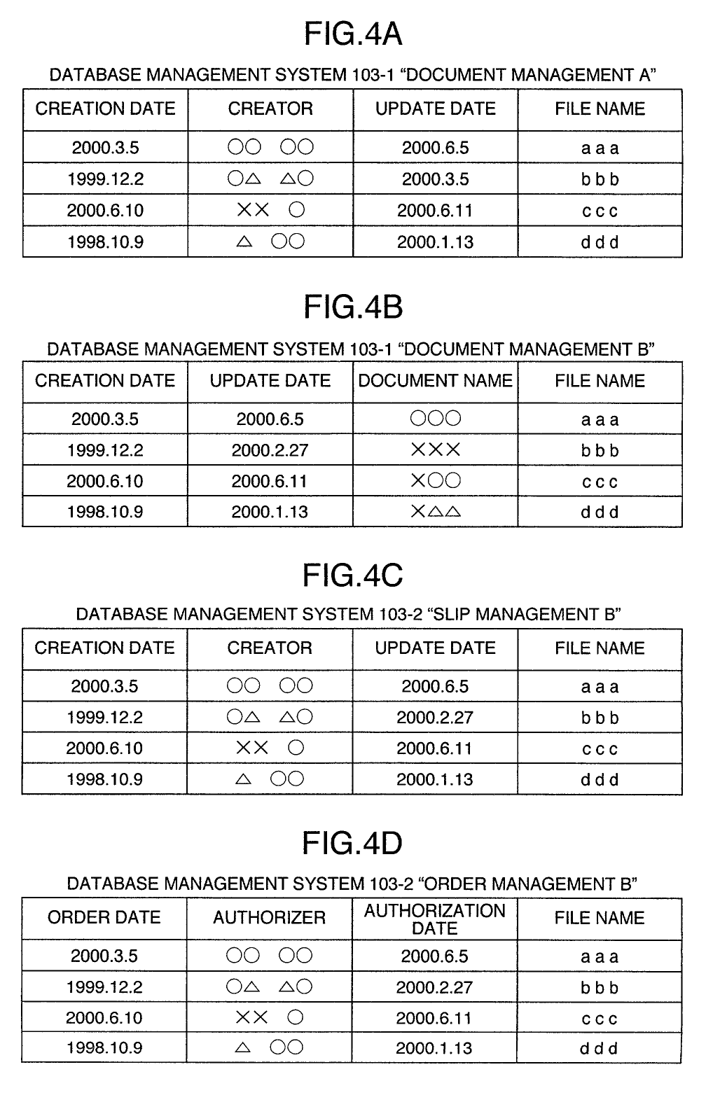

FIGS. 3A and 3B show examples of input to a database access request used in the present invention. For easy understanding, FIGS. 4A-4D show some examples of databases. FIGS. 4A-4D show the databases of the database management systems 103-1 and 103-2.

An access request sent to the access manager 108 has a predetermined common format. FIGS. 3A and 3B show two input examples. In one example, the user does not know the database to be accessed; in the other example, the user knows the database to be accessed. FIG. 3A shows an example of input when the user does not know the database to be accessed. This input request specifies, for example, “Get a creator who updated data on Mar. 5th, 2000”. In response to this access request, the access manager 108 identifies a corresponding database management system and, from the database management system to be accessed, gets a corresponding database name. In addition, the access manager 108 generates an access request that satisfies the user access request and that may be executed by the processor 116. That is, steps 202-211 shown in FIG. 2 are executed.

When the database management system, database, or data item to be processed are known in advance, the access request shown in FIG. 3B is entered. This input request specifies, for example, “Get a creator who updated data on Mar. 5, 2000 from the document management database in the database management system 103-1”. In this case, steps 208-211 shown in FIG. 2 are executed. Therefore, processing is faster than when the database management system and the database are not specified.

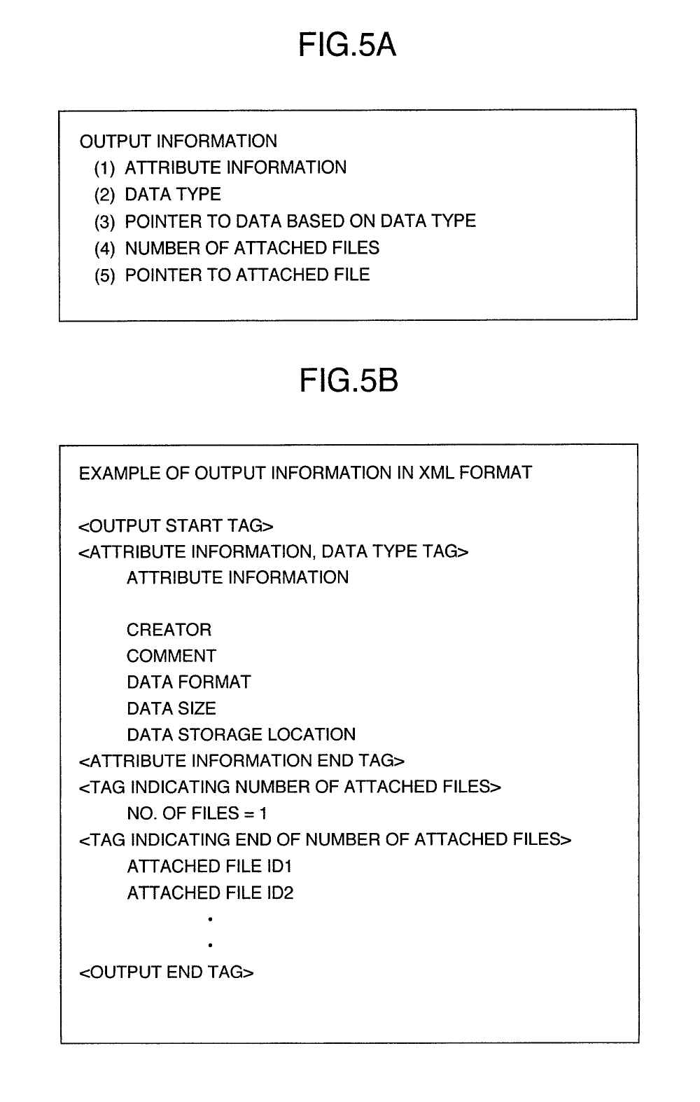

FIGS. 5A and 5B are diagrams each showing information output from the processor 116 when data is acquired from a database.

FIG. 5A shows information that is output at data acquisition time. “Attribute information” indicates the size and the format of acquired data, and “Data type” indicates the data structure. “Pointer to data based on data type” indicates where data is stored. This information may be not only a pointer but an identifier unique in the database. When data is copied from a database to a work directory, this information may also be a path indicating the storage location. Which information is to be used—a pointer, an identifier, or a path—may be predefined.

“Number of attached files” indicates the number of files associated with the acquired data. An associated file is, for example, a file containing information on the division, sex, and so on corresponding to “creator” data. “Pointer to attached file” indicates the location where the attached file is stored. This pointer information may be an identifier unique in the database. When data is copied from a database for a work directory, this information may also be a path indicating a storage location. Which information is to be used—a pointer, an identifier, or a path—may be predefined.

Information that is output at data acquisition time is used when data and its attached files are acquired from a database with no subordination relation and the resulting data and files must be converted to another hierarchical database that has a subordinate relation. That is, the information allows the application to replace the number of attached files with the number of subordinate files and the number of hierarchical levels to generate a subordinate relation and to store data. Conversely, the data, the number of subordinate hierarchical levels, and the number of subordinate files are acquired from a database with a subordinate relation and, from this information, the number of attached files is output. When the data, the subordination relation, and the subordinate files are acquired from a hierarchical database with a subordination relation and this hierarchical database must be converted to another database with no subordination relation, the information acquired above allows the application to replace the number of hierarchical levels and the number of subordinate files with the number of attached files and to store data.

FIG. 5B shows an example of output in a generalized XML format.

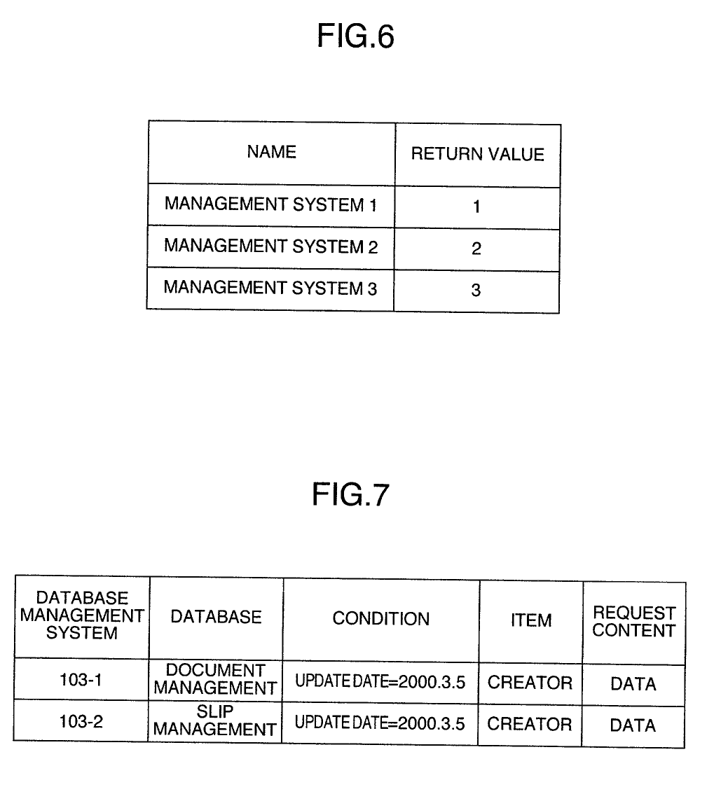

FIG. 6 shows an example of the definition table 109 in the application system 101. The definition table 109 defines the names of database management systems and the return values from the database management systems. The access manager 108 uses this definition table to find the return value from a database management system and identifies a database management system that may be accessed.

FIG. 7 shows an example of the access information table 110. The access information table 110 contains database management system names, database names, data item names, conditions, and request contents. The request content indicates which table entry—database management system, database name, data item, and data—the access request is requesting. For example, in the input examples shown in FIGS. 3A-3B, the request content is “data” because data “creator” stored in the database is requested. When the request content is “database management system”, the name of a database management system that may be accessed is requested. The access manager 108 generates this access information table based on information entered from the user or received from the database management system.

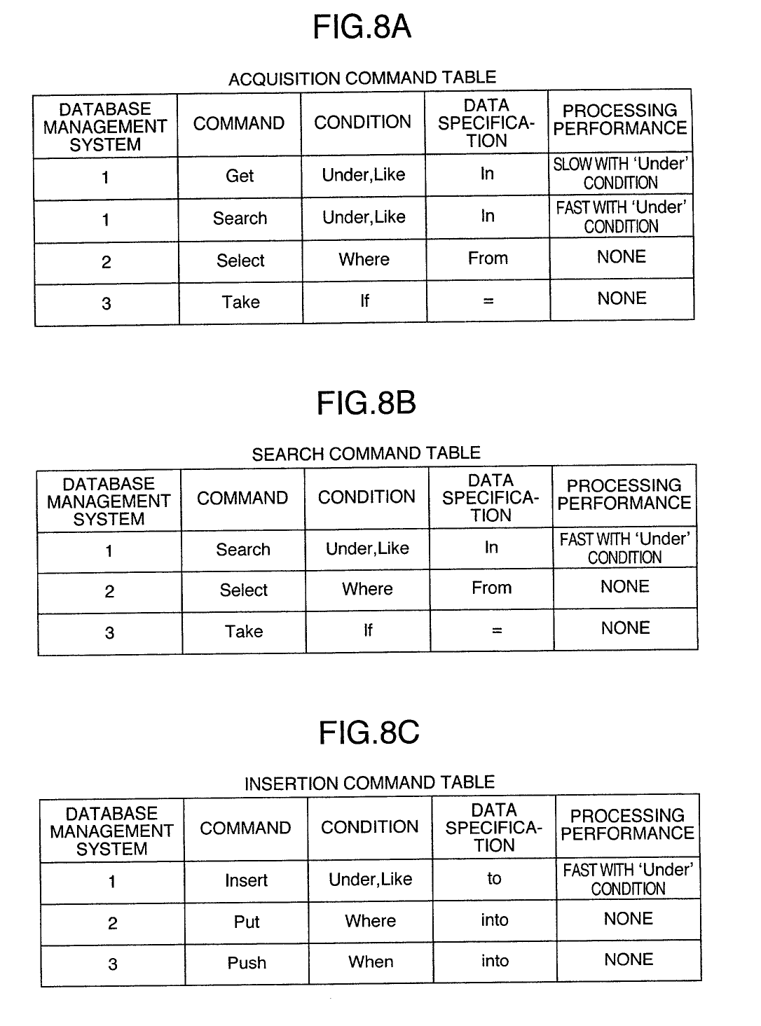

FIGS. 8A-8C show examples of the command translation table 111 in the application system 101. FIGS. 8A to 8C show an acquisition command table, a search command table, and an insertion command table, respectively. The access manager 108 uses this command translation table to translate a request, received from the application processor 107, to a command that may access each database management system. As in the acquisition command table in which “Get” and “Search” are defined for database management system 1, this table may be defined freely according to the type of command and the number of commands owned by each database management system. Which of a plurality of equivalent commands is to be used may be specified by the processing performance column. For example, if the same information may be acquired both by the Get command and by the Search command but if the processing performance varies according to the condition specified by the access request (for example, “Under”, “Like” shown in FIGS. 8A to 8C), the command which acquires data more quickly under some specific condition at that time is automatically selected according to the specification in that column. Other processing performance factors, such as the database state (whether indexing is already processed) or the network connection conditions, may also be defined to select more efficient commands.

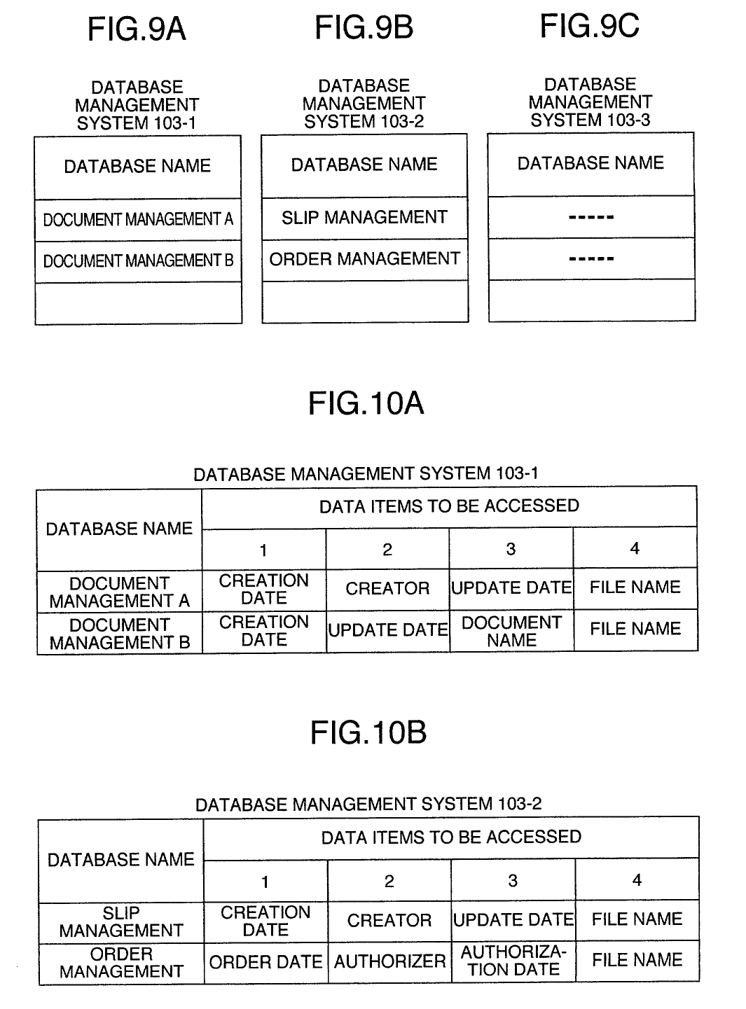

FIGS. 9A-9C show examples of the database name list table 112 maintained in the database management systems. FIGS. 9A-9C, respectively show that, at least “Document management A” and “Document management B” are managed in the database management system 103-1 and that at least “Slip management” and “Order management” are managed in the database management system 103-2. In response to a request from the access manager 108, the processor 116 sends a database name defined in the list.

FIGS. 10A and 10B show examples of the data item list table 113 maintained in a database management system. The data items are defined for each database. This data item list may be created by acquiring data items from a database or may be defined by the user. In response to a request from the access manager 108, the processor 116 sends the data items defined in a list.

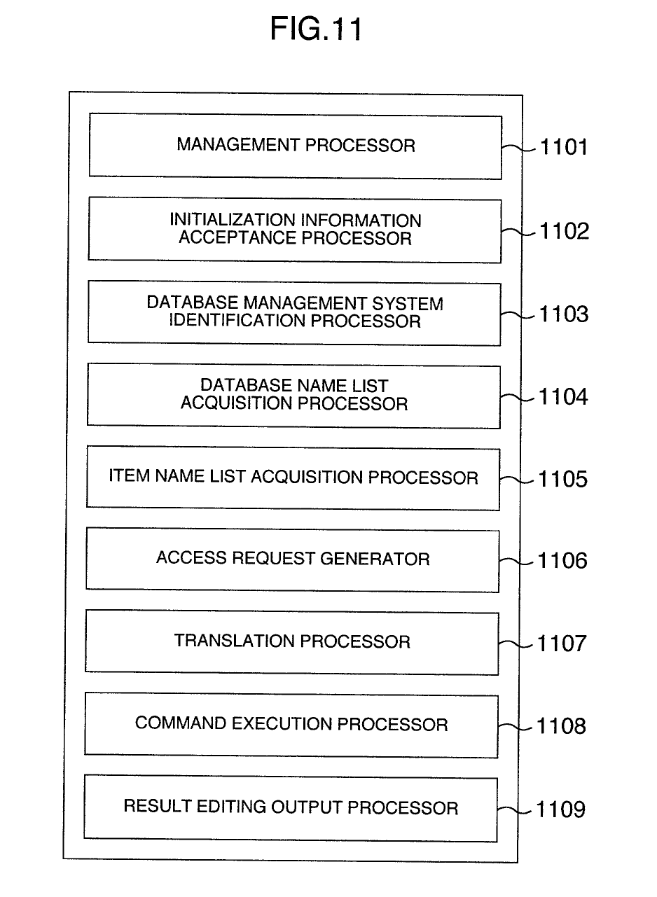

FIG. 11 is a diagram showing the configuration of the access manager 108. A management processor 1101 controls the start/end of operation. It starts or ends operation upon receiving a start request or an end request from the application processor 107. An initialization information acceptance processor 1102 accepts initialization information, such as various settings or a maximum output size, from the application processor 107. A database management system identification processor 1103 references the definition table to identify a database management system that may be accessed. A database name list acquisition processor 1104 acquires a database name list registered with a database management system. An item name list acquisition processor 1105 acquires a data item list registered with a database to be accessed. An access request generator 1106 generates an access request based on the access information table. A translation processor 1107 uses the command translation table 111 to translate commands. A command execution processor 1108 executes processing for a database and gets a result. A result editing output processor 1109 edits an execution result and outputs it. During editing, this processor edits an execution result, acquired from a database, into the common format for output. For example, when the information acquisition request shown in FIG. 3A is entered, the processor extracts common output information, such as the information shown in FIG. 5A, from the information included in the acquired output result of the database management system, formats the extracted information, and then outputs it in the common output format (for example, the format shown in FIG. 5B).

Processing performed by the access manager 108 will be described.

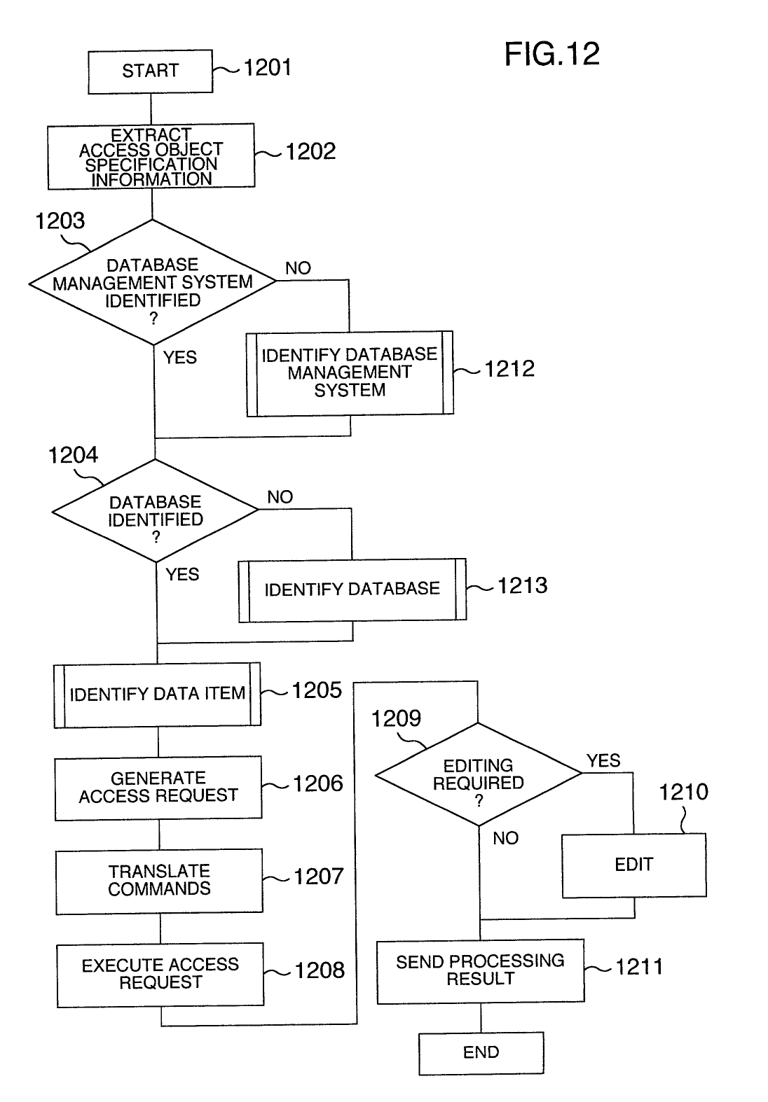

FIG. 12 is a flowchart showing the processing performed by the access manager 108.

In response to an access request from the application processor 107 (1201), the access manager 108 extracts access object identification information and stores the extracted access object identification information in the access information table 110 (1202).

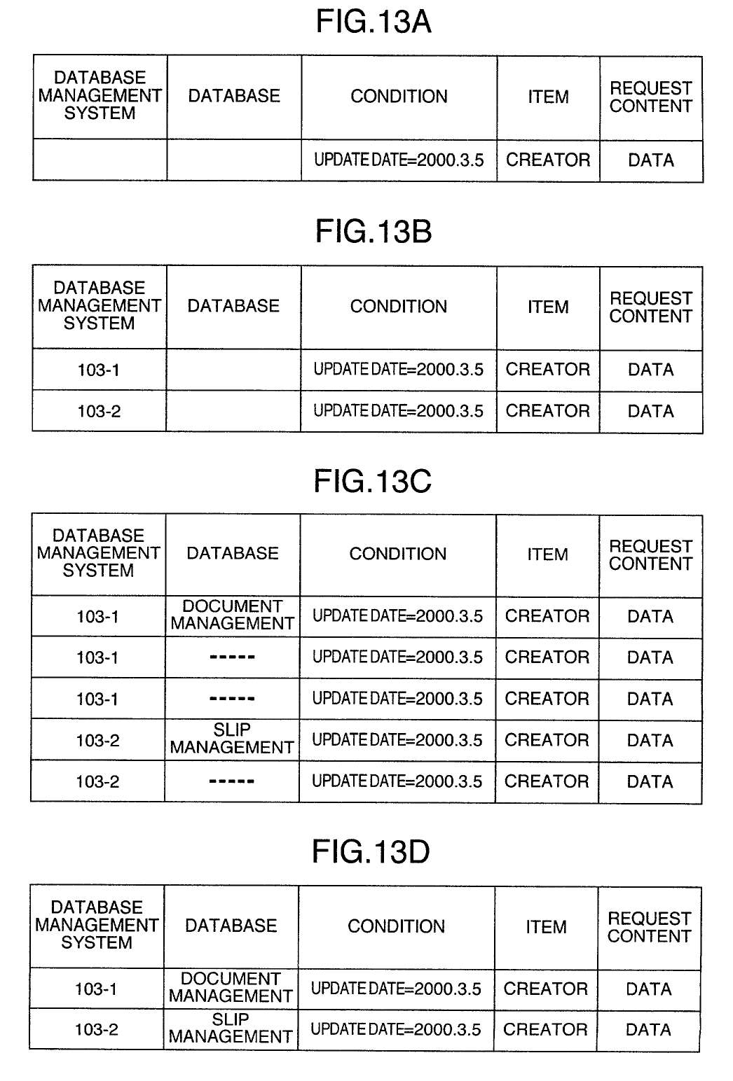

The access object identification information includes “database management system”, “database”, “data item”, “acquisition condition”, and “request content”. For example, when the request shown in FIG. 3A is entered, “data item”, “acquisition condition”, and “request content” are stored in the access information table 110 as shown in FIG. 13A.

Next, the access information table 110 is referenced to check to see if the database management system is identified (1203). If it is not, the database management system identification processor 1103 identifies the database management system (1212).

Next, the access information table 110 is referenced to check to see if the database name is identified (1204). If it is not, the database name list acquisition processor 1104 acquires the database name (1213).

Next, the item name list acquisition processor 1105 acquires the data items corresponding to the database management system and the database defined in the access information table 110 (1205).

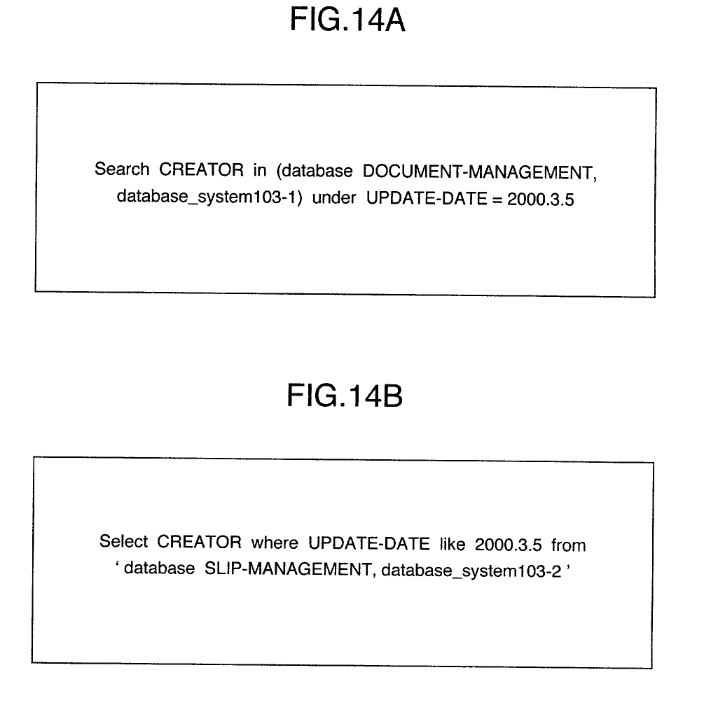

Next, using the access information table 110, an access request to be issued to the processor 116 is generated (1206). The access information table shown in FIG. 13D is generated in steps 1203-1205. An access request to the processor 116 is generated based on this table. Next, the translation processor 1107 uses the command translation table 111 to translate the generated access request to commands that may access the processor 116 according to the format, usage, and syntax of each database management system (1207). FIGS. 14A and 14B show the access requests generated in this manner for execution by the processor 116. As shown in this figure, a command is generated for each database management system.

Next, the command execution processor 1108 sends the access requests, which have been translated to commands, to the processor 116 for execution (1208). When the processing result is received, a check is made to see if editing is requested (1209). Editing, if requested, is executed (1210), and the processing result is sent back to the application processor 107 from which the request was sent (1211).

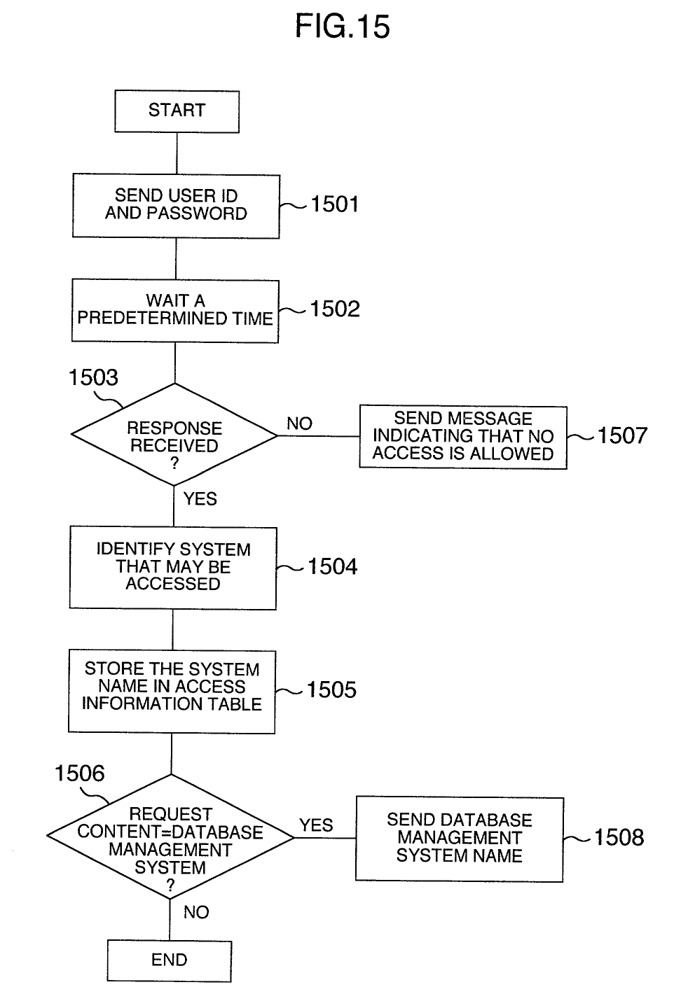

FIG. 15 is a flowchart of processing executed by the database management system identification processor 1103 to identify a database management system.

The database management system identification processor 1103 sends the user ID and the password, received from the application processor 107, as well as access permission information, to the processor 116 (1501). The identification processor waits a predetermined time for the processor 116 to send a return value (1502). Upon receiving a return value (1503), the identification processor identifies the database management system based on the definition table 109 (1504), and stores the name of the identified database management system in the access information table 110 (1505). FIG. 13(b) shows the access information table 110 when the database management systems 103-1 and 103-2 returned responses.

If no return value is received, the identification processor sends a message to the application processor 107 indicating that no database management system may be accessed (1507) and ends the processing shown in FIG. 12.

After the name of the identified database management system is stored in the access information table 110 (1505), a check is made to see if the request content in the access information table 110 is “Identify database management system” (1506). If the request content is “Identify database management system”, the identification processor sends the database management system name stored in the access information table 111 to the application processor 107 (1508) and ends the processing shown in FIG. 12. If the request content is not “Identify database management system”, the identification processor ends processing to execute the processing 1204 shown in FIG. 12.

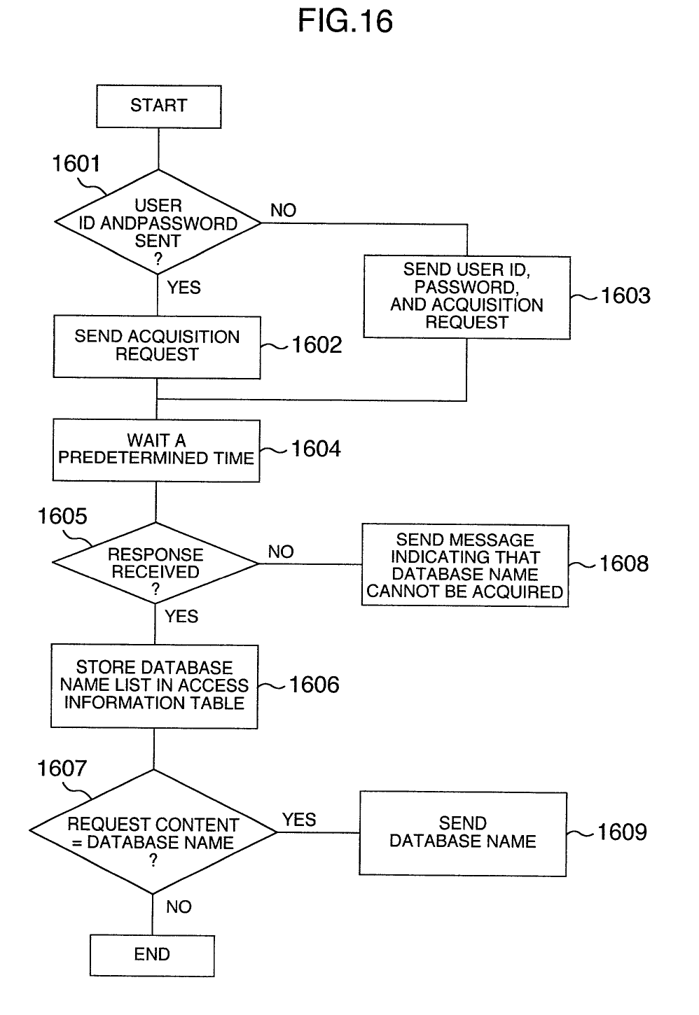

FIG. 16 is a flowchart of processing executed by the database name list acquisition processor 1104 to identify a database name.

The database name list acquisition processor 1104 checks if the user ID and the password have already been sent to the processor 116 (1601). If they have already been sent, the acquisition processor sends a database name list acquisition request to the processor 116 of a database management system defined in the access information table 110 (1602). If the user ID and the password have not yet been sent, the acquisition processor sends a database name list acquisition request, as well as the user ID and the password, to the processor 116 of a database management system defined in the access information table 110 (1603). The acquisition processor waits a predetermined time for the processor 116 to send a response (1604). When a database name list is sent (1605), the acquisition processor stores the database name list in the access information table 110 (1606). FIG. 13C shows the access information table 110 in which the database names sent from the database management systems 103-1 and 103-2 are stored. That is, the database names defined in the database name tables of the database management systems 103-1 and 103-2, shown in FIGS. 9A-9B, are stored.

If no response is received within the predetermined time, the acquisition processor sends a message to the application processor 107 indicating that a database name cannot be acquired (1608) and ends the processing shown in FIG. 12.

After the database names are stored in the access information table 110, the acquisition processor checks if the request content column in the access information table 110 is “Database name” (1607). If the request content is “Database name”, the acquisition processor sends the names of the database management system and the database to the application processor 107 (1609) and ends the processing.

If the request content is not “Database”, the acquisition processor ends processing to execute the processing 1205 shown in FIG. 12.

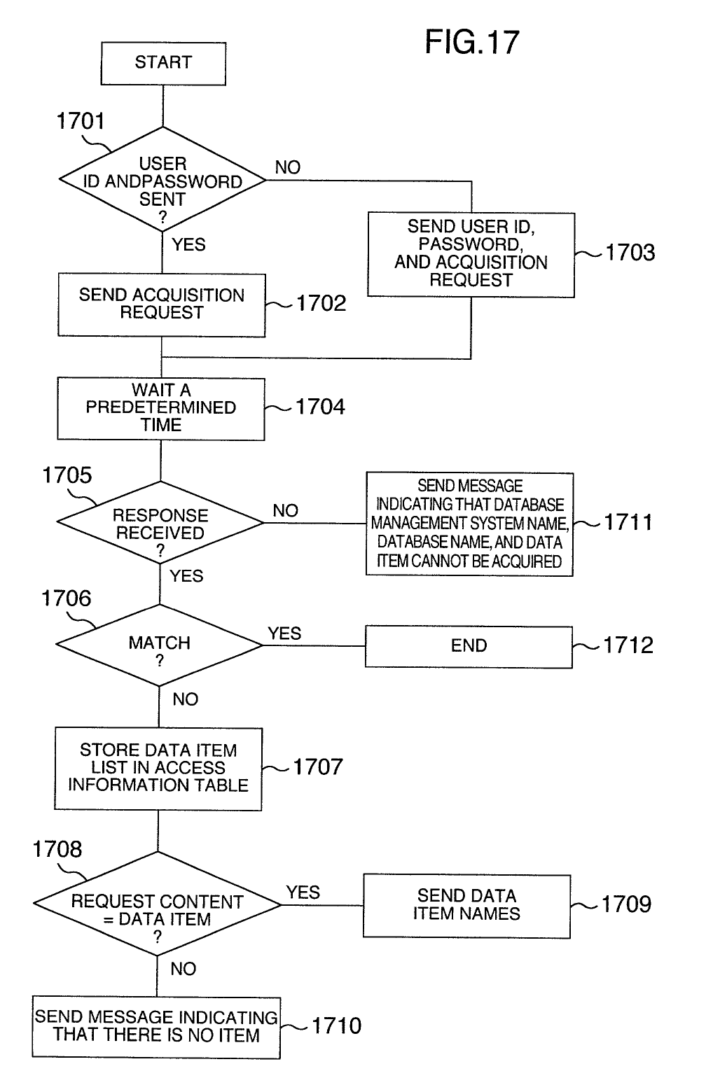

FIG. 17 is a flowchart of processing executed by the item name list acquisition processor 1105 to acquire a data name list.

The item name list acquisition processor 1105 checks if the user ID and the password have already been sent to the processor 116 (1701). If they have already been sent, the acquisition processor sends a database name defined in the access information table 110 and a data item list acquisition request to the processor 116 of a database management system defined in the access information table 110 (1702). If the user ID and the password have not yet been sent, the acquisition processor sends the user ID, the password, a database name defined in the access information table 110, and a data item list acquisition request to the processor 116 of a database management system defined in the access information table 110 (1703). The acquisition processor waits a predetermined time for the processor 116 to send a response (1704). When a data item list is not sent, the acquisition processor sends a message to the application processor 107 indicating that a database management system name, a database name, and a data item name cannot be acquired and ends processing (1711).

When a data item list is received (1705), the acquisition processor compares it with the data items stored in the access information table 110 (1706). If the received data item list includes one or more data items in the access information table 110, the acquisition processor ends processing to execute step 1206 shown in FIG. 12 (1712). In the description below, assume that the received date item list is the one shown in FIG. 10 and that the current access information table 110 is the one shown in FIG. 13C. When the data items of “Document management A” received from the database management system 103-1 are compared with “Document management A” (first row) of the access information table 110, a match occurs in “Update date” and “Creator”. Therefore, the first row is not deleted. Next, when the data items of “Document management B” received from the database management system 103-1 are compared with “Document management B” (second row) of the access information table 110, a match occurs only in “Update date”. There is no data item that matches “Creator” in the access information table 110 and, therefore, the information in the second row is deleted. Similarly, the data items received from the database management system 103-2 are compared with the access information table 110. After this processing, the rows that are not deleted are those shown in FIG. 13D.

If no match occurs between the received data items and the access information table, the received data item list is stored in the data item in the access information table 110 (1707). Next, a check is made to see if the request content of the access information table 110 is “Data item” (1708). If the request content is “Data item”, the acquisition processor sends the stored data item list to the application processor 107 (1709) and ends the processing shown in FIG. 17. If the request content is not “Data item”, the acquisition processor sends the names of the database management system and the database, as well as a message indicating that there is no corresponding data item, to the application processor 107 (1710) and ends the processing in FIG. 17.

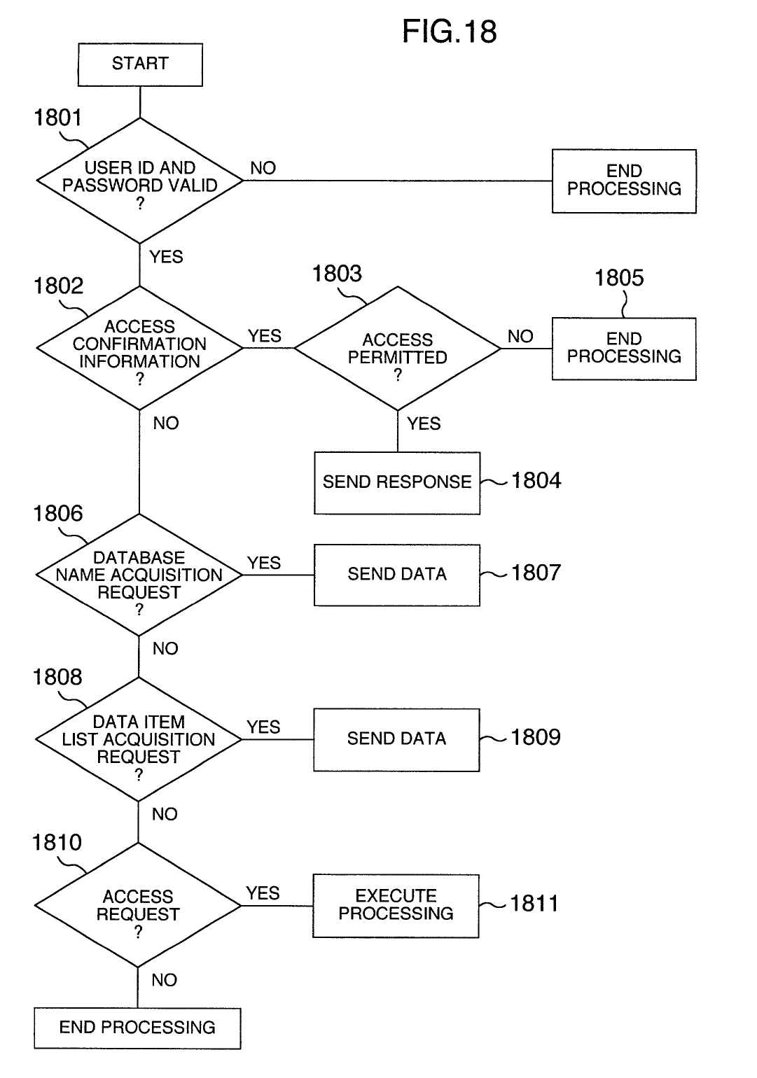

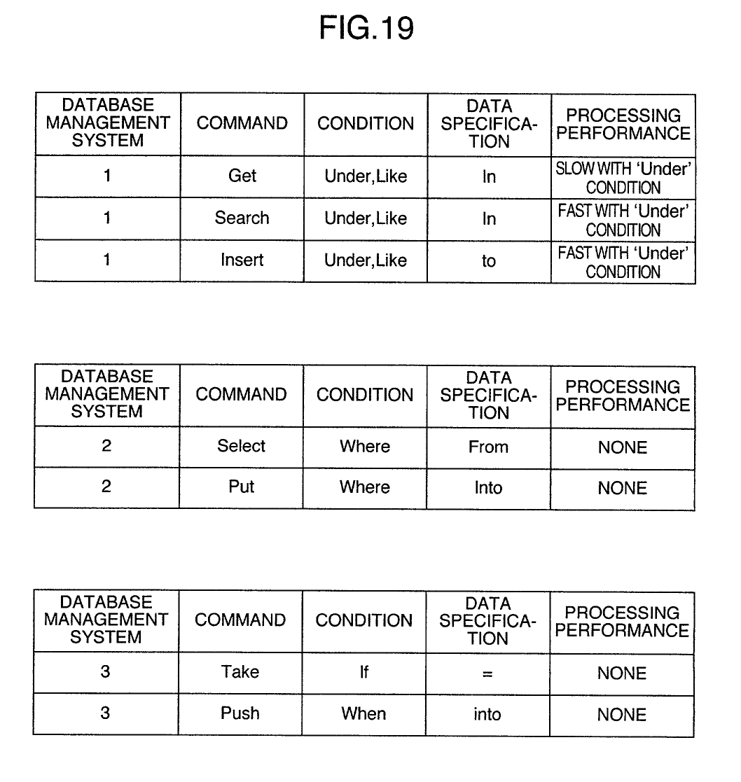

FIG. 18 is a flowchart showing the processing of the processor 116 of a database management system.

The processor 116 checks if the received user ID and the password match those registered with the database not shown in the figure (1801). If they do not match, the processor ends processing. If they match, the processor executes the steps that follow. In this manner, the processor 116 authenticates the request using the user ID and the password.

If the user ID and the password match those registered with the database, the processor checks if the received information is access confirmation information (1802). If the information is access confirmation information, the processor checks the processing state (for example, the load) of the database management system (1803). If access is permitted, the processor sends a response (return value) (1804). If access is not permitted, the processor ends processing (1805). Note that whether or not access is permitted is judged according to the system load (for example, CPU load) information and access permission information defined in the table in advance.

If the information is not access confirmation information, the processor checks if the received information is a database name acquisition request (1806). If the information is a database name acquisition request, the processor sends the data stored in the database name list table 112 (1807).

If the information is not a database name acquisition request, the processor checks if the received information is a data item list acquisition request (1808). If the information is a data item list acquisition request, the processor sends the data stored in the data item list table 113 (1809).

If the received information is not a data item list acquisition request, the processor checks if the received information is an access request (1810). If the received information is an access request, the processor executes processing for the corresponding database (1811).

If the received information is not an access request, the processor ends processing.

As described above, the method in the first embodiment allows the user to get desired data even if he or she does not know the names of a database management system and a database.

In addition, the user may get data items in a database to which he or she may gain access and, therefore, know the structure of a database generated by others such as a database manager. This allows the user to add or delete data. With this ability, the user can use databases, for example, to collect questionnaire data. In addition, a database management system authenticates users to select those who may access databases.

Next, a second embodiment of the present invention will be described.

In the second embodiment, the access manager 108 gets a command translation list from a database management system to access databases.

The system configuration is similar to that shown in FIG. 1 except that a database management system has a command translation list table comprising a database management system name, command list, condition, data specification, processing performance, and so on.

In addition, the access manager 108 has a command translation table generation processor added to the configuration shown in FIG. 11. This processor gets a command translation list from a database management system to generate command translation tables such as those shown in FIG. 8.

Processing executed by the command translation table generation processor will be described more in detail.

The command translation table generation processor references the access information table 110 to send a command translation list acquisition request to a database management system that is defined in the table. The generation processor gets the command translation list if it is available, classifies the commands according to the type (acquisition command, search command, insertion command), and generates the command translation tables such as those shown in FIG. 8. If the command translation list is not available, the generation processor sends a message to the application processor 107 indicating that a command translation list is not available.

The command translation table generation processor is executed before step 1207 in FIG. 12.

To implement the second embodiment, a step in which a command translation list is sent in response to a request is executed after the authentication step during execution of the processor 116 shown in FIG. 18.

Except the processing described above, the processing of the second embodiment is the same as that of the first embodiment.

As described above, in addition to the advantage of the first embodiment, the second embodiment allows the user to get desired data even if different commands are used in a database management system. The user can also add a database management system as necessary.

Next, a third embodiment will be described.

In the third embodiment, authentication executed in the processor 116 in the above embodiments is executed in the access manager 108.

To do so, the access manager 108, with an authentication processor, is connected to a database with which user IDs and passwords are registered. The authentication processor receives a user ID, a password, and an acquisition request from the database management system identification processor 1103, database name list acquisition processor 1104, and item name list acquisition processor 1105 shown in FIG. 11. When the user ID and the password match those registered with the database, the authentication processor sends the request to the processor 116. More specifically, in the processing flowchart, the user is authenticated in step 1501 in FIG. 15, in step 1603 in FIG. 16, and in step 1703 in FIG. 17.

This eliminates the need for the processor 116 to execute authentication shown in FIG. 18.

If the access manager 108 authenticates the user as described above, a database name list, a data item list, and a command translation list may be acquired from a database management system, not separately as described in the first and second embodiments, but at a time.

That is, because the access manager 108 may authenticate the user even when these lists are acquired at a time, the user is identified and then data may be read from, added to, or deleted from a database. Therefore, steps 202-207 are not necessary, the overall system performance increases, and the user can read, update, and delete data more quickly.

In this case, the management processor 1101 of the access manager 108 executes an additional step that is not included in the flowchart shown in FIG. 12. That is, it regularly sends a request to acquire the lists at a time to the processor 116. In response to this request, the processor 116 sends a database name list, a data item list, and a command translation list to the access manager 108. The access manager 108 stores the acquired lists in the table.

When the access manager accepts an access request, it acquires a database management system name, a database name, or data items from the tables, in which the lists are stored, in step 1501 in FIG. 15, in step 1602 or 1603 in FIG. 16, and in step 1702 or 1703 in FIG. 17.

The first to third embodiments are as described above. Although provided in all application systems in the above embodiments, the access manager 108 may be provided in only one of the systems. This reduces the load of an application system without the access manager 108, allowing it to install therein other application programs.

In addition, to reduce the load of all application programs, a server with the function of the access manager 108 may be provided in the system to allow the application system to access a database management system via this server. In particular, the access manager 108 that performs authentication reduces the total system size.

If there is a plurality of databases that provide data at a charge in the first to third embodiments, the charge may be defined in the database name list table. When the access manager 108 acquires a database name list (for example, in step 1609 in FIG. 16), it sends the acquired database name list, as well as the charge, to the application processor. The application processor displays the database names and the charges as follows:

Database management system 1

Database A: $1

Database B: $1.5

Database management system 2

Database C: No charge

If the user selects only items in the first to third embodiments, he or she may not notice that the database is available at a charge. Displaying whether or not databases are available at a charge allows the user to select databases and to prevent them from wasting money. The charge for each data item may be defined as follows:

Database management system 1

Database A

Item a: ¢50: Item b: ¢30

Database B

Item a: ¢20: Item c: ¢10

Database management system 2

Database C: No charge

This allows a database manager to set the charge more flexibly, thus providing the user with data at a lower charge.

In the embodiments, the user may get database management system names, a database name list, and an item name list from heterogeneous databases as described above. Therefore, the user may access a database even if he or she does not know their names. In addition, the user need be familiar with commands because a request is translated to the commands of each database management system. Therefore, the user may get or delete data from, and update data of, a database without concerning about database management systems.

In addition, because a command execution result is edited into the common format for output in the embodiments, the user may use the resulting information without concerning about the output format of each database management system. In this case, information on the number of attached files and the locations of the attached files are also output in the common output format. Thus, required and sufficient information may be acquired for an application to convert a database without a subordination relation to a database with a subordination relation or, conversely, to convert a database with a subordination relation to a database without a subordination relation.

The method according to the present invention enables the user to easily access heterogeneous databases.

While the preferred form of the present invention has been described, it is to be understood that the present invention is not limited to the embodiments but that modifications will be apparent to those skilled in the art without departing from the spirit of the present invention.

What is claimed is:

1. A database management method for managing databases connected to a network, comprising the steps of:
acquiring, from database management means, information regarding a database and a data item to be accessed, said data management means being connected to the network; and
accessing said database to be accessed using said acquired information regarding said database and said data item, in response to an access request from at least one application.

2. The database management method according to claim 1, wherein the information regarding said database and data item to be accessed is acquired at a predetermined interval.

3. The database management method according to claim 1, further comprising the steps of:
acquiring a command for accessing the database in conjunction with the information regarding said database and data item; and
sending the access request from the application to said database to be accessed using the information rearding said database, data item, and a command.

4. The database management method according to claim 1, wherein said database to be accessed is identified from a response from a database side and the information regarding said database and said data item is acquired from said identified database.

5. The database management method according to claim 1, wherein a database that may be accessed is identified based on a return value sent from the database management means connected to the network.

6. A database management method for accessing a database in response to a request from an application, said method comprising the step, by said database, of:
managing at least a number of attached files to be accessed and pointers to the attached files and outputting information regarding said number of attached files and on attached file storage locations.

7. A database management system comprising:
access information acquisition means for acquiring information regarding a database and a data item to be accessed from database management means for managing a database and connected to a network;
access request generation means for generating an access request to be sent to said database to be accessed using the acquired information regarding said database and data item, in response to an access request from at least one application; and
access means responsive to the generating access request, for accessing from said access means the data base; and
means for outputting a result of the access to said application.

8. The database management system according to claim 7,
wherein said access information acquisition means further acquires a command for accessing the database and said access request generation means generates an access request using the acquired command.

9. The database management system according to claim 7,
wherein said access information acquisition means acquires the database and the data item at a predetermined interval.

10. The database management system according to claim 7,
wherein said access information acquisition means identifies the database to be accessed based on a return value from the database to acquire the information on the data item of the identified database.

11. The database management system according to claim 7,
wherein said access information acquisition means acquires the information on the database and the data item from database management means for managing at least one database.

12. A database management system accessing a database in response to an access request from at least one application, said system comprising:
access request checking means for checking if information identifying the database is included in the access request from the application.

13. The database management system according to claim 12, wherein said access request checking means checks if information identifying the data item is included in the access request from the application.

14. A database system comprising:
a plurality of database management systems, each managing databases; in response to a request from an application, and
wherein each database management system manages at least a number of attached files to be accessed and pointers to the attached files and outputs information regarding the number of attached files and attached file storage locations in response to the access request from said application.

15. The database system according to claim 14, wherein said application acquires information regarding the number of attached files and the attached file storage locations from a database managing data with a subordination relation and, based on the information, performs conversion for accessing a database managing data without a subordination relation.

16. The database system according to claim 14, wherein said application acquires information regarding the number of attached files and the attached file storage locations from a database managing data without a subordination relation and, based on the information, performs conversion for accessing a database managing data with a subordination relation.

17. A program for implementing a method of accessing a database by a computer, said method comprising the steps of causing a computer to acquire information on a database and a data item to be accessed and, sending an access request received from at least one application to the database to be accessed using the information regarding the database and the data item to be accessed.

18. The recording medium according to claim 17, wherein said program further causes the computer to check if the access request received from said application includes database identification information.
